(19) United States
(12) Patent Application Publication
(10) Pub. No.: US 2026/0181050 A1
(43) Pub. Date: Jun. 25, 2026

(54) Systems And Devices For Agnostic Control Of Electromagnetic Devices

(71) Applicant: The Charles Stark Draper Laboratory, Inc., Cambridge, MA (US)

(72) Inventors: Julianne Jensen, Cambridge, MA (US); Khadija Panirwala, Cambridge, MA (US); Jaime A. Trejo, Cambridge, MA (US); Robyn Bernstein, Cambridge, MA (US)

(21) Appl. No.: 19/419,915

(22) Filed: Dec. 15, 2025

Related U.S. Application Data
(60) Provisional application No. 63/738,575, filed on Dec. 24, 2024.

(51) Int. Cl. H04L 67/125; H04L 69/08

(52) U.S. Cl. CPC H04L 67/125; H04L 69/08

(57) ABSTRACT

Systems and methods for controlling electromagnetic devices are disclosed. The system can include one or more processors configured to communicate with one or more radio managers to provide commands and receive information from one or more devices associated with each respective radio manager. The one or more processors can condition the responses and requests from and to the radio managers to be compatible with an application operating on a user device.

### CROSS-REFERENCES TO RELATED APPLICATIONS

This application claims the benefit of U.S. Provisional Application No. 63/738,575 filed December 24, 2024, the entire contents of which are incorporated herein by reference.

### TECHNICAL FIELD

Aspects of the disclosure generally relate to systems and methods for controlling electromagnetic devices, especially software defined radios.

### BACKGROUND

Control of software defined radios can vary across platforms.

### SUMMARY

Presented herein are systems and methods for controlling electromagnetic devices. In some cases, the system can communicate with a variety of subservices such as radio managers. Each radio manager can be associated with one or more types of devices, such as software-defined radios. The various radio managers can operate independently of each other and can communicate with a data handler. The data handler can transform information between the various radio managers and provide information to an application and accept commands for the various software defined radios through the application.

In counter-RCIED (radio-controlled improvised explosive device) electronic warfare operations, military operators frequently deploy multiple software-defined radio systems from different manufacturers to detect and defeat radio-frequency triggers across various frequency bands. For example, Modi systems manufactured by Sierra Nevada Corporation and SAM (Special Application Module) systems from Penn State Applied Research Laboratory are commonly deployed together in the same operational environment. However, each vendor provides proprietary control software that operates only with their respective hardware and often uses incompatible data structures and application programming interfaces (APIs).

This incompatibility forces operators to run multiple separate applications (often on multiple physical laptops) to control different radio systems during a single mission. In field operations where operators work from vehicles or portable stations near areas of interest, managing multiple control applications creates significant cognitive burden. Operators divide attention between disparate interfaces while attempting to coordinate frequency band assignments, monitor health status across systems, and execute time-sensitive countermeasures. The inability to see unified status information or execute coordinated control commands across vendor systems presents an operational limitation in scenarios where response time and situational awareness are essential.

At least one aspect of the present disclosure is directed to a system for controlling software-defined radios. The system can include a set of subservices. Each subservice of the set of subservices can be associated with a respective type of device. The system can include one or more processors coupled with memory. The one or more processors can maintain an identification of the set of subservices and their associated types of device. The one or more processors can receive, from a user device, a request in a first form for information related to a device. The one or more processors can identify a subservice of the set of subservices associated with a type of the device. The one or more processors can transform the request from the first form to a second form compatible with the identified subservice. The one or more processors can provide the request in a second form to the identified subservice. The one or more processors can receive, from the identified subservice, the information in the second form. The one or more processors can transform the information from the second form to the first form compatible with a display. The one or more processors can display, on the user device, the information related to the device in the second form.

At least one aspect of the present disclosure is directed to a method for controlling electromagnetic devices. The method can include maintaining, by one or more processors coupled with memory, an identification of a set of subservices. Each subservice of the set of subservices can be associated with a respective type of device. The method can include receiving, by the one or more processors from a user device, a request in a first form for information related to a device. The method can include identifying, by the one or more processors, a subservice of the set of subservices associated with a type of the device. The method can include transforming, by the one or more processors, the request from the first form to a second form compatible with the identified subservice. The method can include providing, by the one or more processors, the request in a second form to the identified subservice. The method can include receiving, by the one or more processors, from the identified subservice, the information in the second form. The method can include transforming, by the one or more processors, the information from the second form to a first form compatible with a display. The method can include displaying, on the user device, the information related to the device in the second form.

In certain aspects, the systems and methods described herein provide a specific technical improvement to the operation of distributed software-defined radio systems. The disclosed data handler performs protocol-level normalization, timing control, and semantic reconciliation of heterogeneous vendor messages in a manner that enables real-time command and status exchange across incompatible radio platforms. The data handler manages polling intervals, filters unsolicited traffic, and regulates subservice interactions to prevent overload conditions and latency spikes that arise when multiple radios operate with different update rates and proprietary communication formats. By resolving these incompatibilities at a system level, the disclosed architecture improves the functioning of both the radios and the computing environment that coordinates them, enabling unified control and monitoring that cannot be achieved through conventional, vendor-specific applications.

### BRIEF DESCRIPTION OF THE DRAWINGS

The foregoing and other objects, aspects, features, and advantages of the disclosure will become more apparent and better understood by referring to the following description taken in conjunction with the accompanying drawings. The accompanying drawings are not intended to be drawn to scale. Like reference numbers and designations in the various drawings indicate like elements. For purposes of clarity, not every component may be labeled in every drawing. In the drawings:

FIG. 1 is a system for controlling electromagnetic devices deployed in an environment.

FIG. 2 illustrates a block diagram of a system for controlling electromagnetic devices;

FIG. 3 illustrates a block diagram of a process for receiving a request and providing information in a system for controlling electromagnetic devices;

FIG. 4 illustrates a method flow of a process for controlling electromagnetic devices; and

FIGS. 5-10 illustrate example user interfaces to be presented by a system for controlling electromagnetic devices.

### DETAILED DESCRIPTION

Reference will now be made to the embodiments illustrated in the drawings, and specific language will be used here to describe the same. It will nevertheless be understood that no limitation of the scope of the disclosure is thereby intended. Alterations and further modifications of the features illustrated here, and additional applications of the principles as illustrated here, which would occur to a person skilled in the relevant art and having possession of this disclosure, are to be considered within the scope of the disclosure.

Described herein are systems and methods for controlling electromagnetic devices. Conventional systems, platforms, and devices for controlling or receiving information from an electromagnetic device, such as a software defined radios, has traditionally been restricted to devices directly associated with a respective platform or system. This has been due, in part, to security necessities across a system architecture preventing control access by other systems. This has also been due at least in part to incompatibility across various systems arising from differing standards, poll rates, etc. This can result in latency issues across a system comprising various types of software defined radios across various disparate systems. It further complicates control and display of information related to an interconnected system of various types of software defined radios.

To account for these and other technical issues, the system and methods provided herein enable communication and control across a variety of disparate software defined radio systems, enabling central control of the various systems while also maintaining security and access control for each system of the various systems. In this manner, updates and authentication can happen on a per-subservice basis while enabling overarching control of various aspects of the system.

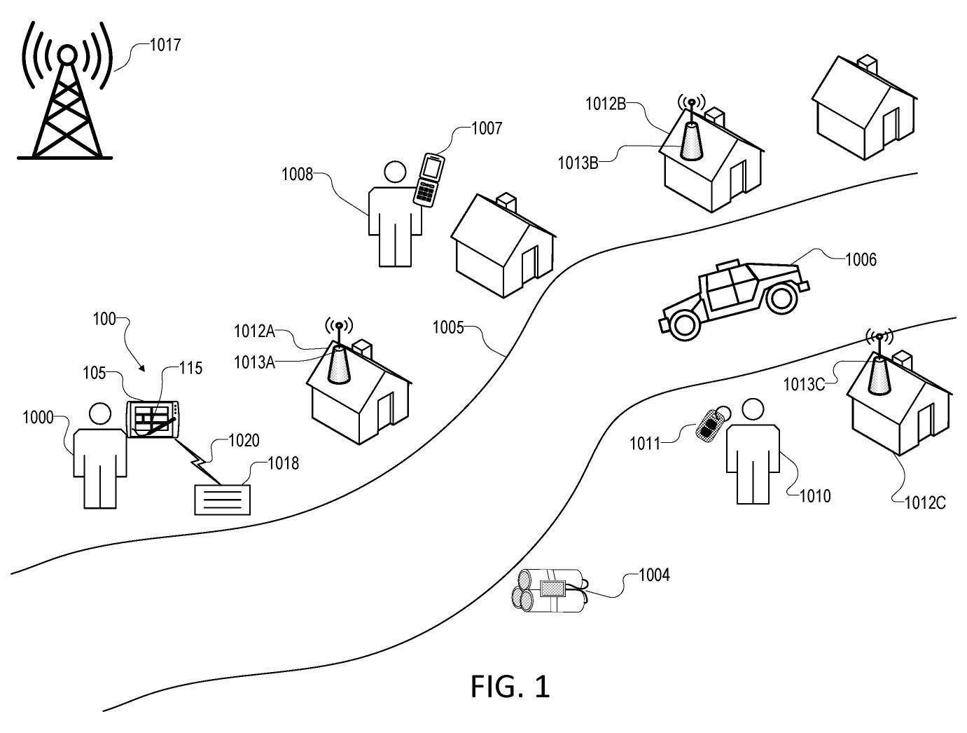

Referring to FIG. 1, an operator 1000 is operating such a system 100 for controlling electromagnetic devices in an environment. In the example of FIG. 1, the system 100 is deployed in a counter-RCIED (radio-controlled improvised explosive device) application.

In particular, an improvised explosive device (IED) 1004 is positioned adjacent to a roadway 1005 along which a vehicle 1006 is traveling. The environment includes multiple potential radio-frequency trigger sources that could detonate the IED 1004. A first person 1008 is shown with a mobile phone device 1007, a second person 1010 is shown with a key fob or remote control device 1011, and multiple structures 1012A, 1012B, 1012C are equipped with wireless access points 1013A, 1013B, 1013C (such as Wi-Fi routers or other RF-emitting devices). Any of these RF sources could serve as a triggering mechanism for the IED 1004, either intentionally or inadvertently.

The operator 1000 is positioned in the environment and is equipped with a user device 105 (depicted as a tablet computer) executing an application with a user interface 115 as described in greater detail below. The user device 105 is in communication with a stack 1018 (or chassis) containing a number of software defined radios via a communications link 1020 (e.g., a wired connection such as Ethernet or a wireless connection such as Wi-Fi, cellular, or other RF data link). In some examples, the stack 1018 is a modular rack assembly with multiple individual radio modules arranged in vertically stacked configuration, where each module may correspond to a different radio manager and may be configured for different frequency bands, protocols, or mission types (as is described in greater detail below).

Through the user interface 115 on the user device 105, the operator 1000 can visualize the inventory of available devices in the stack 1018, monitor their operational and health status, and command the devices to perform specific electronic warfare techniques. In this counter-RCIED scenario, the operator 1000 may direct one or more of the devices to perform detection operations to identify active or potential RF triggers in the environment, and subsequently command jamming, RF flooding, or other defeat techniques to prevent detonation of the IED 1004. Different modules within the stack 1018 may be assigned to different frequency bands or mission types. For example, with a first module monitoring cellular frequencies associated with a cellular tower 1017 (to counter the mobile phone trigger from the first person 1008), a second module monitoring key fob frequencies (to counter the remote control trigger from the second person 1010), and a third module monitoring Wi-Fi bands (to counter the wireless access point triggers 1013A-C).

It should be appreciated that the different modules and radio managers in the stack 1018 are not necessarily designed to operate together, and each radio manager may have an entirely different communication protocol, data structure, and control scheme from the other radio managers. The system 100 unifies the operation of these heterogeneous radio managers such that the operator 1000 can interact with all the different modules in the stack 1018 through a common user interface 115 that presents a seamless, integrated control experience. From the operator's perspective, the disparate underlying systems appear as a single, cohesive system despite their fundamental incompatibilities. As is described in greater detail below, a data handler (not explicitly shown in FIG. 1) serves as an abstraction layer that transforms commands from the user interface 115 into the appropriate format for each radio manager controlling respective devices in the stack 1018. The data handler similarly transforms status, health, and detection information from the devices and their associated radio managers into a unified presentation on the user interface 115. This architecture enables the operator 1000 to maintain comprehensive situational awareness and exercise coordinated control over multiple disparate software defined radio (SDR) systems through a single interface.

As depicted, the operator 1000 monitors the electromagnetic environment, identifies potential threats, and commands appropriate countermeasures, all through the user interface 115 on user device 105 (rather than prior approaches that would have required multiple separate control applications or physical laptops for each different type of SDR in the stack 1018). The ability to control Modi modules, SAM modules, and potentially other SDR types through a single unified interface can reduce cognitive load on the operator 1000, improve response time in threat scenarios, and enable coordinated multi-band countermeasures that would be impractical with separate control systems.

The deployment scenarios for the system 100 vary based on mission requirements and operational constraints. In some configurations, the stack 1018 is mounted in or on a vehicle, with the operator 1000 controlling the system from within the vehicle while positioned near the area of interest. In other configurations, the stack 1018 is man-portable, carried in a backpack configuration where the operator 1000 transports the radio modules on foot and deploys them at a tactical location. In still other configurations, the stack 1018 is set up on a tripod or fixed mount in a stationary position, with the operator 1000 controlling it remotely via the communications link 1020. Regardless of physical deployment, the operational workflow typically involves the operator 1000 accessing the user interface 115 to visualize an inventory of available devices in the stack 1018, including their type, operational status, and health status. The operator 1000 monitors the electromagnetic environment through status information provided by the devices via their respective radio managers and the data handler and, upon detecting potential threats or suspicious RF activity, the operator 1000 commands specific modules to transition from monitoring mode to operational mode and execute defeat techniques such as jamming, RF flooding, or other countermeasures. The operator 1000 monitors the effectiveness of the countermeasures through real-time status updates displayed on the user interface 115. Throughout this workflow, the operator 1000 interacts with a single unified interface rather than switching between multiple vendor-specific applications, reducing cognitive load and enabling faster response to time-sensitive threats.

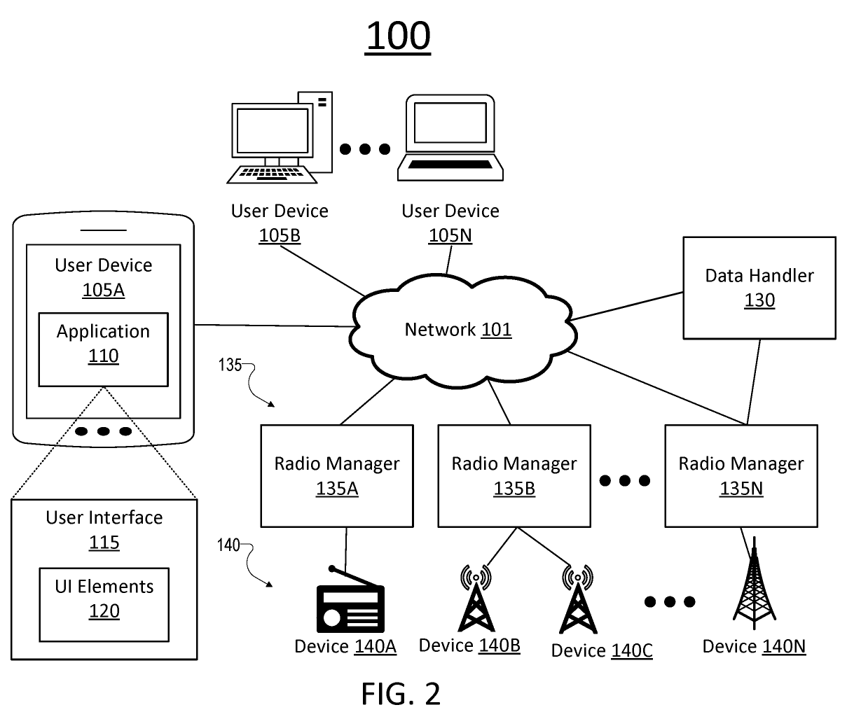

Referring now to FIG. 2, depicted is a block diagram of the system 100 for controlling electromagnetic devices. In an overview, the system 100 can include at least data handler 130, one or more radio managers including a first radio manager 135A, a second radio manager, 135B to an Nth radio manager 135N (individual radio managers being referred to also as “the radio manager 135”), one or more devices including a first device 140A, a second device 140B to an Nth device 140N (individual devices being referred to also as “the device 140”) and a set of user devices 105A-N (hereinafter generally referred to as user devices 105 or client devices 105), communicatively coupled with one another via at least one network 101. At least one user device 105 (e.g., a first user device 105A, a second user device 105B, and an Nth user device 105N, as depicted) can include an application 110 (or at least one application). The application 110 can include or provide at least one user interface 115 with one or more user interface (UI) elements 120. The data handler 130 and/or one or more of the radio managers can include or have access to at least one database. The database can store, maintain, or otherwise include information associated with one or more of the devices. In some cases, each radio manager 135 can include a database for storing information related to an associated device of the device 140. The functionality of the application 110 can be performed in part on the data handler 130

In further detail, the data handler 130 can (sometimes herein generally referred to as a computing system or a service) be any computing device comprising one or more processors coupled with memory and software and capable of performing the various processes and tasks described herein. The data handler 130 can be in communication with the one or more user devices 105 and the one or more radio managers via the network 101. The data handler 130 can be situated, located, or otherwise associated with at least one server group. The server group may correspond to a data center, a branch office, or a site at which one or more servers corresponding to the data handler 130 is situated. The data handler 130 can receive, execute, or accept a request to control one or more of the devices by the application 110 on respective user devices 105.

The user device 105 (sometimes herein referred to as an end user computing device or client device) can be any computing device comprising one or more processors coupled with memory and software and capable of performing the various processes and tasks described herein. The user device 105 can be in communication with the data handler 130 via the network 101. The user device 105 can be a smartphone, other mobile phone, tablet computer, wearable computing device (e.g., smart watch, eyeglasses), or laptop computer. The user device 105 can be used to access the application 110. In some embodiments, the application 110 can be downloaded and installed on the user device 105 (e.g., via a digital distribution platform). In some embodiments, the application 110 can be a web application with resources accessible via the network 101.

The application 110 executing on the user device 105 can be an application to control the one or more devices. The application 110 can be used to request data, status, or other information regarding the operating of the devices or the radio managers. The application 110 can be used to provide a control, prompt, or other request to the radio managers or the devices.

The application 110 can include, present, or otherwise provide a user interface 115 including the one or more UI elements 120 to a user of the user device 105 in accordance with a configuration on the application 110. The UI elements 120 can correspond to visual components of the user interface 115, such as a command button, a text box, a check box, a radio button, a menu item, and a slider, among others. In some embodiments, the application 110 can be an application to control the one or more devices via the user interface 115. For example, the application 110 can request an instruction for presentation of a message on the user device 105. The message can be presented textually, as an image, as a video, or other presentation. The message can include information related to one or more of the devices and/or the radio managers. For example, the message can include information related to a strength of a signal from the device 140, quality of a signal from the device 140, location of the device 140, warning or status messages from the device 140, devices associated with a first radio manager 135A, other devices recognizable by the device 140, among others.

The radio manager 135 can be any software or hardware capable of communicating with a particular type of the device 140. In some cases, the radio manager 135 is associated with a subset of the devices. The subset of the devices associated with a first radio manager 135A can be based on a manufacturer of the respective devices 140, a wireless protocol of the respective devices 140, a location of the respective devices 140, a configuration of the device 140 (i.e., mounted vs. dismounted), among others. In some cases, the radio manager 135A can be associated with a type of the devices, such as a type determined or differentiated by a wireless protocol of the devices, a location of the devices, a manufacturer of the devices, among others. The radio manager 135 can communicate with its respective devices 140 via a private network, hardwired connection, etc. In some cases, a first radio manager 135A associated with a device 140A of a first type of devices cannot communicate with a second radio manager 135B or its associated devices of a second type, devices 140B or 140C. In some cases, each radio manager 135 can have one or more types of devices 140 associated with it. Each radio manager 135 can communicate or be coupled with the data handler 130. In some cases, each radio manager 135 maintains its own database or repository of information about its respective devices 140. In some cases, each radio manager independently maintains its database, such as at a predetermined interval or responsive to a request from the data handler 130.

Each database associated with the radio managers can store and maintain various resources and data associated with its respective devices 140 and/or the data handler 130. Each database can include a database management system (DBMS) to arrange and organize the data maintained thereon. Each database can be in communication with the data handler 130. While running various operations, the data handler 130 can access the databases to retrieve identified data therefrom. The radio manager 135 can provide information from its respective database in accordance with a request from the data handler 130 for such information about the radio manager 135 or its devices 140.

In some examples, the radio managers and devices 140 implement built-in test (BIT) capabilities that execute at specific intervals or events. For example, a series of built-in tests may execute when a device 140 boots up, when switching between different load stash configurations (software packages that enable different signal processing techniques), or at predetermined intervals during operation. These tests monitor various parameters including component temperatures, power supply voltages, signal processing performance, and communication link integrity.

When a built-in test detects a fault, warning, or error condition, the radio manager 135 reports this status information to the data handler 130. The data handler 130 transforms the fault information into a format compatible with the application 110 and triggers appropriate notifications on the user interface 115. The user interface 115 may update status indicators (such as changing a health status icon from green to yellow or red), display notification popups alerting the operator to the specific issue, and provide a dedicated interface (such as a built-in test results screen) where the operator can drill down to identify the specific physical component experiencing the fault. This health monitoring capability is particularly useful in field operations where device failures could compromise mission effectiveness, as it enables the operator to quickly identify failing components and either repair them, swap to redundant modules, or adjust mission parameters to work around the limitation. The unified presentation of health status across multiple vendor systems through the common interface prevents situations where a fault in one vendor's system goes unnoticed because the operator is focused on a different vendor's control application.

The devices can be or include any devices capable of providing and receiving electromagnetic signals. In some cases, the devices include software defined radios. Software defined radios (SDRs) can be or include any combination of software and hardware capable or communication, such as a radio configured to communicate in one or more frequency bands. In some cases, the device 140 can provide one-way communication, such as including only a transceiver or only a receiver. In some cases, the device 140 can provide two-way communication, including capabilities to both transmit and receive. In some cases, the device 140 can have varying or adjustable frequency bands, amplitudes, bandwidths, impendence, among other radio characteristics.

In some examples, multiple devices 140 are physically arranged in a modular stack or chassis configuration. A stack can include a master input/output module and a number (e.g., up to ten) of extension modules (sometimes called "slices"), where each module is an individual device 140 associated with a particular radio manager. The modules in a stack are connected via wired connections (such as Ethernet) and may include a mix of different device types. For example, a single stack might contain three Modi modules from Sierra Nevada Corporation and two SAM modules from Penn State Applied Research Laboratory, each optimized for different frequency bands or mission types. The modular architecture addresses physical hardware constraints inherent in software-defined radios. A radio module optimized for wide-area frequency coverage may sacrifice fine-grain spectral resolution, while a module fine-tuned to a narrow frequency band provides detailed analysis of that band but misses activity in adjacent spectrum. Different modules can also be loaded with specialized signal processing software for particular missions, where one module may excel at detecting and analyzing Wi-Fi signals, another at cellular protocols, and another at key fob or remote control frequencies common in RCIED applications. By combining multiple specialized modules in a single stack, the system 100 enables comprehensive coverage across multiple frequency bands and mission types, with the data handler 130 providing unified control and monitoring of this heterogeneous collection of radio systems through the single application interface.

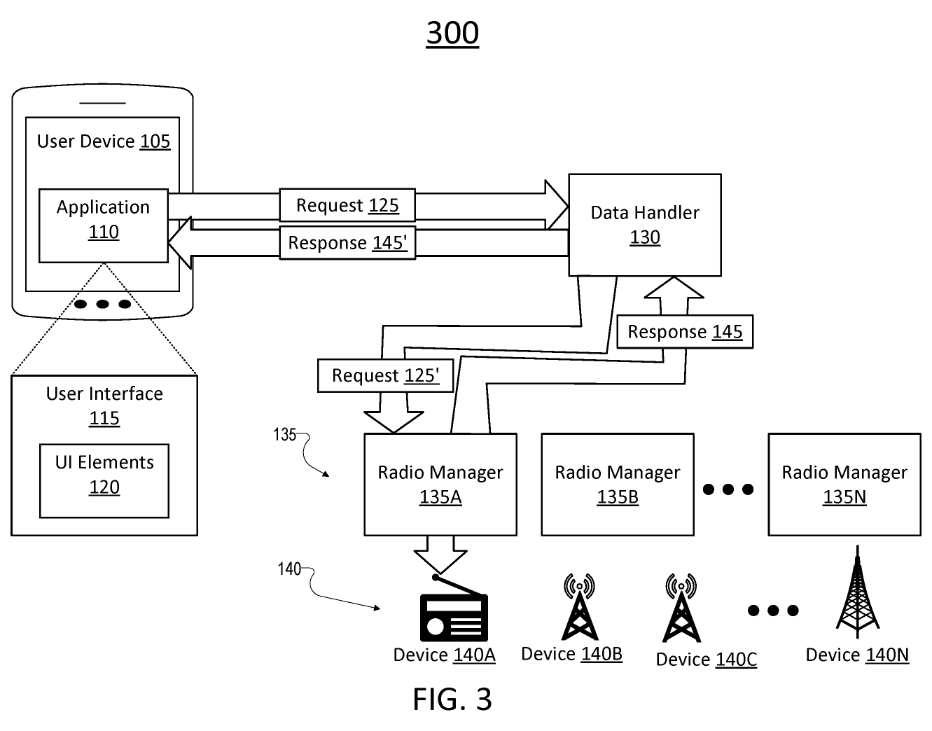

Referring now to FIG. 3, depicted is a block diagram for a process 300 for receiving a request and providing information in a system for controlling electromagnetic devices. The process 300 may include or correspond to operations performed in the system 100. Under the process 300, the data handler 130 can communicate with the radio manager 135 to retrieve, fetch, or otherwise identify or provide information about the device 140 associated with the radio manager 135 for the application 110 on the user device 105. The radio manager 135 can identify or define information associated with its associated device(s) 140 for an instance of the application 110 on the user device 105. The radio manager 135 can provide or relay a command, such as a request for information or performance of a function of the device 140, to its respective device 140.

The data handler 130 can send, provide, or otherwise transmit at least one request 125 or 125’ to the radio manager 135. The request 125 may be to query for information related to the device 140. The data handler 130 can transmit the request 125 responsive to an input in the user device 105 by actuation of one or more of the UI elements 120. The data handler 130 can transmit the request 125’ responsive to an interval of time or a change in information from the device 140 or the radio manager 135.

In some embodiments, the data handler 130 can calculate, identify, or otherwise determine a time at which to send or present the request 125’. In some embodiments, data handler 130 can maintain a timer to count the time elapsed since a response 145, such as an update of information related to the device 140, was received by the application 110. In some cases, the data handler 130 can maintain an identification of which device 140 is associated with which radio manager 135. For example, the data handler 130 can include keys, mappings, SSIDs, or other identifiers of each device 140 as associated with its radio manager 135. In some cases, each radio manager 135 is unaware of or does not communicate with other radio managers.

In some cases, the request 125 can be in a form not identifiable, readable, or receivable by the radio manager 135. For example, the requested information indicated in the request 125 can be in a different language, structure, or encoding than it is stored or received by the radio manager 135. The data handler 130 can transform the request from the first form to a second form compatible with the radio manager 135 identified as associated with the requested information by the data handler 130. For example, the data handler 130 can include a mapping between the types of devices 140 and the application 110. For example, the data handler 130 can include one or more machine learning models capable of classifying, identifying, recognizing, or otherwise translating the request 125 in the first form to the second form.

In general, the transformation performed by the data handler 130 extends beyond simple format conversion or API adapters. The data handler 130 implements semantic mapping and structural reorganization of fundamentally incompatible data models. For example, Modi systems from Sierra Nevada Corporation structure their device information, control commands, and status responses using data schemas, property names, and hierarchical organizations that differ completely from SAM systems from Penn State Applied Research Laboratory. The SAM data structures may be highly nested or convoluted, requiring the data handler 130 to decompose complex structures, extract relevant information from various nested levels, identify semantically equivalent data elements that use different naming conventions, and reconstruct this information into a unified data model compatible with the application 110.

The data handler 130 can maintain mapping tables or configuration data that specify how to navigate different code paths based on device type (e.g., Modi vs. SAM), identify which property names or data fields in each vendor's data structure correspond to conceptually equivalent information (such as device temperature, operational mode, or signal strength), and apply vendor-specific transformation rules to convert between the unified data model used by the application 110 and the proprietary data structures of each radio manager 135. In some examples, the data handler 130 works in coordination with a standardization effort where vendors agree to naming conventions and data format standards. However, the data handler 130 is designed to integrate vendor systems "as is" without requiring vendors to refactor their existing systems, allowing new radio managers to be added to the system 100 using their existing APIs and data structures, with transformation logic added to the data handler 130 rather than requiring changes to vendor systems.

This vendor-agnostic architecture can provide significant operational advantages. It enables rapid integration and deployment of new radio systems without waiting for vendors to modify their proprietary software. It preserves the security and integrity of vendor systems by keeping their internal implementations unchanged. It allows the system 100 to evolve independently from vendor development cycles. The transformation layer in the data handler 130 thus serves as an important abstraction that enables unified control while maintaining compatibility with disparate and independently evolving radio manager systems.

The data handler 130 can identify the radio manager 135 associated with the request 125. For example, the data handler 130 can identify, from the device 140 indicated in the request 125, the radio manager 135 that corresponds to the device 140 indicated in the request 125. The data handler 130 can transform the request 125 in the first form to the request 125’ in the second form compatible with the radio manager 135 that was identified. The data handler 130 can provide the request 125’ to the radio manager 135 that was identified.

The radio manager 135 (also referred to herein as the “subservice(s)”) can control the device 140 based on the received request 125’. In some cases, the radio manager 135 can receive the request 125’ and cause the device 140 to perform an action based on the request 125’. For example, the radio manager 135 can cause the device 140 to change an operating parameter (such as operating frequency, power, bandwidth, etc.) based on the request 125’. For example, the radio manager 135 can cause the device 140 to emit a signal or other communication among a network of similar type devices 140 based on the request 125’. For example, the radio manager 135 can cause zeroization of the device 140, such as deleting the device 140 or removing/resetting operating parameters of the device 140. In some cases, the request 125’ is a request for information from the device 140. For example, the radio manager 135 can provide the request 125’ to the device 140 for information related to an operating parameter, communication, or other such information from the device 140. The device 140 can provide the requested information to the radio manager 135.

In some cases, the radio manager 135 can provide a response 145. In some cases, the response 145 can include the information requested from the request 125’. In some cases, the response 145 can be an acknowledgement of receipt of the request 125’, or performance of an action associated with the request 125’. In some cases, the data handler 130 waits a threshold period of time for an acknowledgement response 145. If the data handler 130 does not receive an acknowledgement response 145, the data handler 130 can provide an error response 145’ to the application 110.

In some cases, the data handler 130 can refuse a response 145 from the one or more radio managers. For example, the radio manager 135A may provide a response 145 including an update of information associated with its associated device 140A more frequently than requested by the application 110 or the data handler 130. The data handler 130 can triage, refuse, or cache the response 145 not requested by the data handler 130 without providing the response 145’ to the application 110. In this manner, the data handler 130 can prevent unnecessary network traffic, thereby improving latency. Furthermore, the data handler 130 can provide consistency across systems by scheduling or accepting response 145 updates from each radio manager 135 at a predetermined interval.

The response 145 can be in a form incompatible with the application 110. In some cases, the data handler 130 can transform the response 145 in the second form incompatible with the application 110 to the first form compatible with the application 110. In some cases, the data handler 130 can remove information from the response 145 to provide the response 145’ to the application 110. For example, the data handler 130 can remove information identifying the radio manager 135 associated with the device 140. In this manner, the underlying operations of the system 100 can be streamlined to reduce latency and excessive information. The data handler 130 can render the response 145 to provide the response 145’ for presentation on the user device 105.

Upon receipt, the application 110 on the user device 105 can render, display, or otherwise present the response 145’. The response 145’ can be presented via the one or more UI elements 120 of the user interface 115 of the application 110 or as a push notification via the user device 105. The response 145’ can include a text box, drop down menu, button, sliding scale, or other UI elements 120 to accept the response 145’ from the data handler 130.

In some embodiments, the application 110 can render, display, or otherwise present the response 145’, independently of the data handler 130. The application 110 can share or have the same functionalities as the data handler 130 as discussed above. For example, the application 110 can maintain a timer to keep track of time elapsed since a request 125.

In some cases, the data handler 130 can receive a prompt to modify one or more of the radio managers or the device 140 directly at the radio manager 135 or the device 140. For example, an admin or other API polling the radio manager 135 or the device 140 may wish to initiate control, modifications, or other changes at the device 140 or radio manager 135 level. The data handler 130 can provide authentication and authorization capabilities. For example, the data handler 130 can process, authenticate, or otherwise provide security measures upon a request to modify or edit the device 140 or radio manager 135. In some cases, the data handler 130 can receive a set of credentials from the user device 105, the radio manager 135, or the device 140 and can authenticate the credentials and identify a radio manager 135 and/or device 140 associated with the credentials. In this example, the data handler 130 can allow for control of the radio manager 135 or the device 140 via the authentication credentials. In some cases, the data handler 130 can restrict access to the device 140 or the radio manager 135 based on the identification of the credentials. For example, the data handler 130 can restrict a set of credentials to read-only operations, restricting the credentials against write operations, among others.

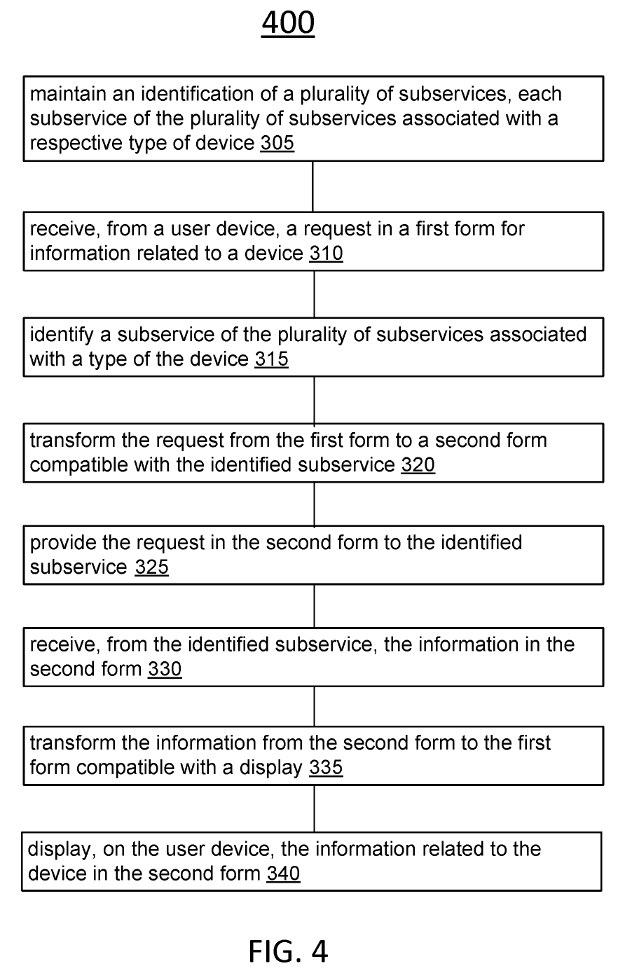

FIG. 4 depicts a process flow 400 for a system for controlling electromagnetic devices. The flow 400 can include ACT 305 to ACT 340. The flow 400 can be performed by example, by components of system 100 or the process 300 shown in FIG. 3, such as the data handler 130, the radio managers, or the devices.

At ACT 305, the flow 400 can include maintaining, by the data handler, an identification of a plurality of subservices. Each subservice of the plurality of subservices can be associated with a respective type of device. For example, the data handler can maintain a repository of each radio manager in communication with the data handler. The data handler can maintain a mapping, listing, or other repository of devices, such as software defined radios, associated with each radio manager. For example, the data handler can identify a type of device and determine, based on the type of the device, a radio manager associated with the device. The type of the device can include a name of the device, a manufacturer of the device, a function of the device, an operating parameter of the device, among others. In some cases, the data handler can maintain an identification of forms which are compatible with the radio manager, the application, among others.

At ACT 310, the data handler can receive, from a user device, a request in a first form for information related to a device. The data handler can receive a request from a user device, or the data handler can generate a request. The request can be or include a request for information from the radio manager or an associated device. The request can be or include a command for the radio manager or an associated device. In some cases, the request is received from the user device in a first form. The first form may not be compatible with the radio manager or the device.

At ACT 315, the data handler identifies a subservice of the plurality of subservices associated with a type of the device. The data handler can identify, based on the type of the device, which subservice (e.g., radio manager) is associated with the device.

At ACT 320, the data handler can transform the request from the first form to a second form compatible with the identified subservice. For example, the data handler can modify the request to be readable by the identified subservice, such as to match a function call or other expected form of the request by the subservice. At ACT 325, the data handler can provide the request in the second form to the identified subservice.

At ACT 330, the data handler can receive, from the identified subservice, the information in the second form. The information can be in a response from the identified subservice. In some cases, the response is in the second form. The second form can be incompatible with the application. At ACT 335, the data handler can transform the information form the second form to the first form. In some cases, the first form is compatible with the application or a user device on which the application is executing.

At ACT 340, the data handler can display, on the user device, the information related to the device in the second form. In some cases, the data handler can render the information related to the device for presentation on the user device, such as through the application.

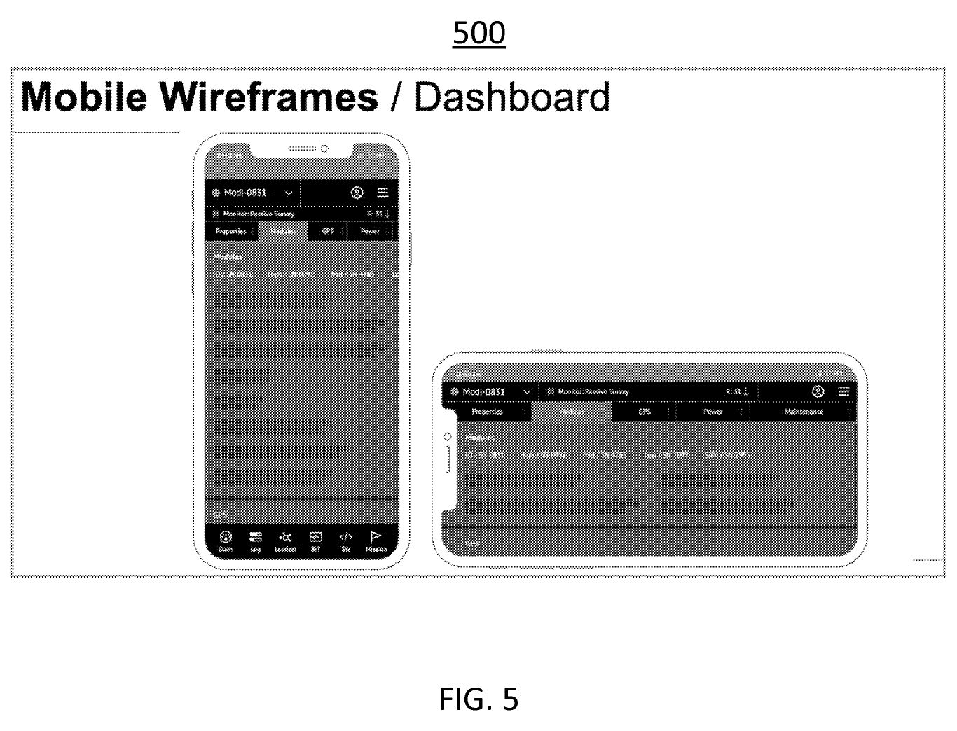

FIGS. 5-10 depict example graphical user interfaces in the system for controlling electromagnetic devices. FIG. 5 shows example mobile wireframes for a dashboard view 500 presented by the user interface 115 on mobile user devices 105. The figure shows two mobile device form factors displaying the same dashboard interface in different orientations.

The left view shows a portrait orientation displaying a device selection dropdown at the top showing "Modi-0831" with status information “Monitor:Passive Survey” and "R: 31" indicating operational status. Below the status dropdown and status information are navigation tabs including "Properties," "Modules" (currently selected and highlighted in blue), "GPS," and "Power." The Modules view displays a list of radio modules in the stack with their identifiers: "IO / SN0831," "High / SN0992," and "Mid / SN4765." Each module entry can be selected or expanded for more details. At the bottom of the screen is a navigation bar with icons for different functional areas including dashboard, log, loadsets, BIT (Built-In Test), SW (software), and Mission.

The right mobile view shows a landscape/tablet orientation of the same dashboard interface with more horizontal screen real estate. The device dropdown "Modi-0831" is again shown at top, along with mission status "Monitor: Passive Survey" and operational indicator "R: 31." The same navigation tabs (Properties, Modules, GPS, Power, Maintenance) are displayed horizontally. The Modules section shows the same three modules (IO/SN 0831, High/SN 0992, Mid/SN4765) plus an additional module "Low/SN7099" and "SAM/SN 2995," demonstrating that the interface can display mixed vendor systems (Modi and SAM modules) in a single unified view. The GPS section is visible below the modules.

Both views demonstrate responsive design where the interface adapts to different screen sizes and orientations while maintaining consistent functionality and information hierarchy. The unified presentation of modules from different vendors (Modi and SAM) in a single module list is an example of the vendor-agnostic control capability of the system 100.

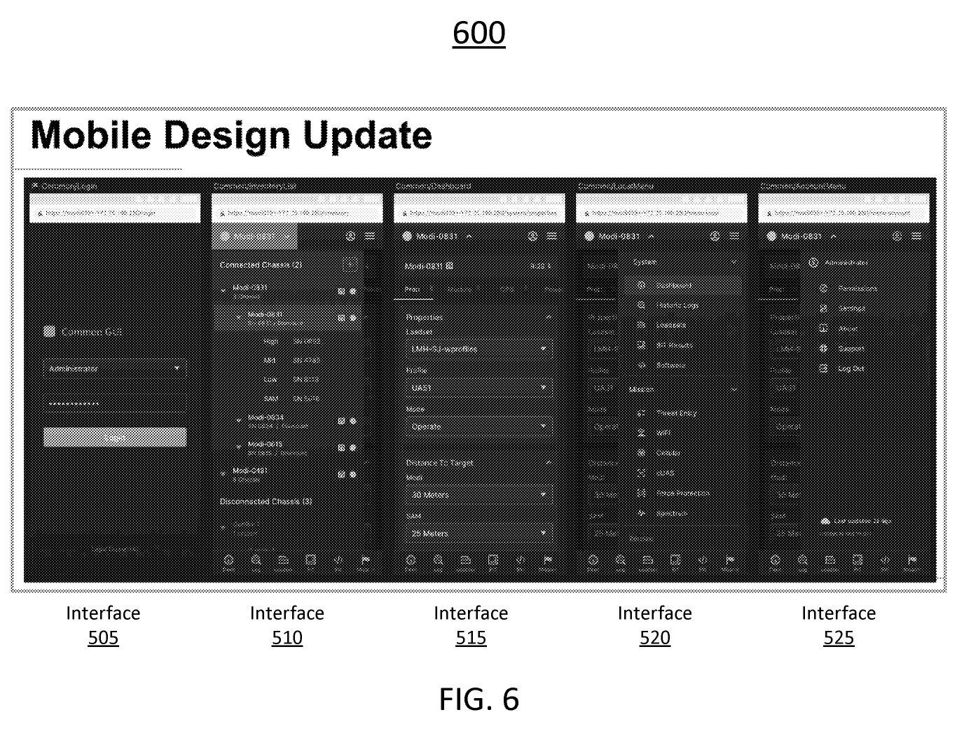

FIG. 6 displays a comprehensive mobile application design 600 showing five distinct interface views that illustrate the authentication workflow and various functional screens of the application 110.

Interface 505 shows an authentication screen with the “Common GUI” branding. The interface includes a user role selector dropdown showing "Administrator," text input fields for user credentials (shown as password dots), and a blue "Login" button. This authentication portal controls access to radio managers and devices 140 based on user credentials and assigned roles.

Interface 510 shows the inventory list view displayed after successful authentication. The screen displays "Common/InventoryList" at the top with the URL path. The main area shows "Connected Chassis (2)" as a collapsible section header with a plus icon. Expanded beneath this are individual device entries including "Modi-0831" with its modules listed (Modi-0831 S/N 0831 / Dismount showing High SN 0992, Mid SN4765, Low SN8113, SAM SN5016), "Modi-0834" (S/N 0834 / Dismount), and "Modi-0815" (S/N 0815 / Dismount), and "Modi- 0491" entries. Each entry has status indicators, such as green/red dots showing health status or a semantic-colored icon showing operational status. Below this is a "Disconnected Chassis (3)" section listing additional offline devices. The hierarchical tree structure with expand/collapse controls allows operators to see the full inventory of available systems and their current connection status. At the bottom of the screen is a persistent navigation bar with six icons providing quick access to core functional areas: "Dash" (dashboard/home), "Log" (historic logs), "Loadsets" (software configurations), "BIT" (built-in test results), "SW" (software/system information), and "Mission" (mission execution interfaces). This bottom navigation bar remains accessible across multiple screens, enabling operators to quickly switch between major functional areas without navigating through hierarchical menus.

Interface 515 shows a device properties/configuration screen titled "Common/Dashboard" displaying detailed information for "Modi-0831." The top shows the device selector "Modi-0831" with mission status "Monitor: Passive Survey" and indicator "R: 29." Below are horizontal tabs for Properties (currently selected), Modules, GPS, and Power. The Properties panel displays configuration controls including a "Loadset" dropdown showing "LMFI-5J-wprofiles," a "Profile" field showing "UAS1," a "Mode" selector showing "Operate," and "Distance To Target" settings with separate dropdowns for "Modi" (30 Meters) and "SAM" (25 Meters).

Interface 520 shows a device properties/configuration screen titled “Common/LocalMenu.” The interface shows "System" and "Mission" dropdown selectors at top, with the System menu expanded showing options including Dashboard, Historic Logs, Loadsets, BIT Results, and Software submenu items. The Mission menu is also expanded showing options including Threat Entry, WiFi, Cellular, cUAS, Force Protection, and Spectrum. At the bottom is a "Zeroize" button in red, implementing the remote sanitization capability discussed in the specification.

Interface 525 shows the account/profile menu accessed from the top-right user icon. The screen displays "Common/AccountMenu" with the logged-in user shown as having Administrator privileges. The menu shows user profile options including "Permissions," "Settings," "About," "Support," and "Log Out." A timestamp indicator shows "Last updated 2s ago" and version information "v0.000.005.1.0.0." This interface allows operators to manage their session, adjust personal settings, and view system information.

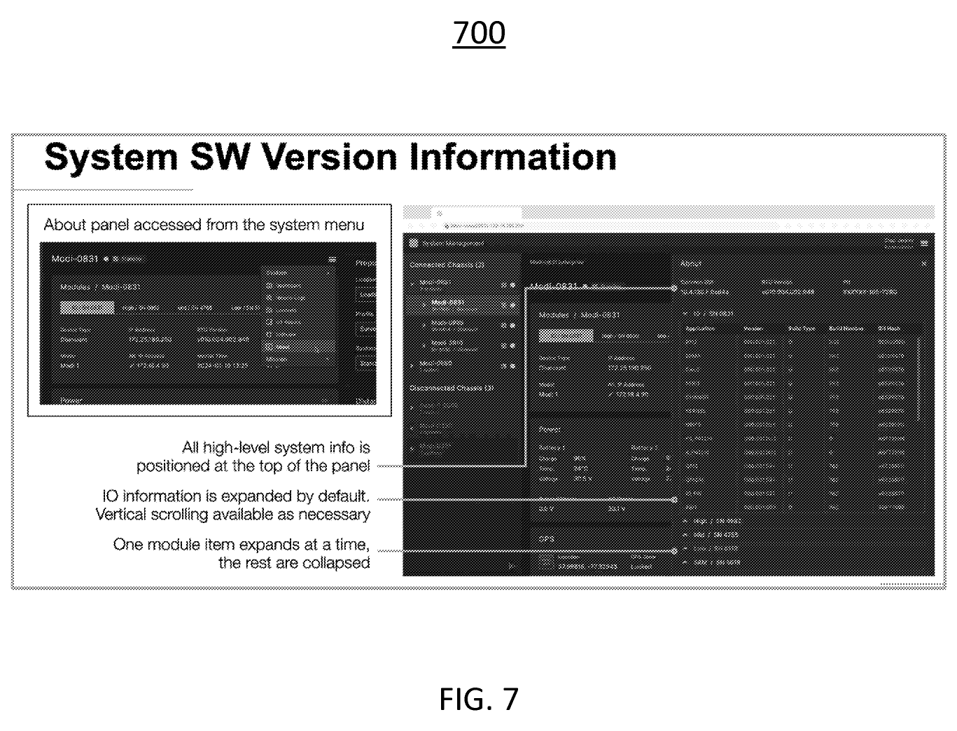

FIG. 7 displays interface 700 showing system software version information accessible through an About panel from the system menu.

The left side of the figure shows a user selecting the “About” menu item. The right side of the figure shows the “About” information screen displaying detailed version data for the Common GUI. The About screen also shows an expandable list of modules (IO/SN 0831, High/SN 0992, Mid/SN4765, Low/SN8113, SAM/SN5016). When a module is selected and expanded, it displays a table showing software component information including Application name, Version number, Build Type, Build Number, and Git Hash for each software component installed on that module. The About screen enables operators to verify software versions across all modules in the system, which is essential for troubleshooting, ensuring compatibility, and tracking software updates across the heterogeneous collection of devices from different vendors.

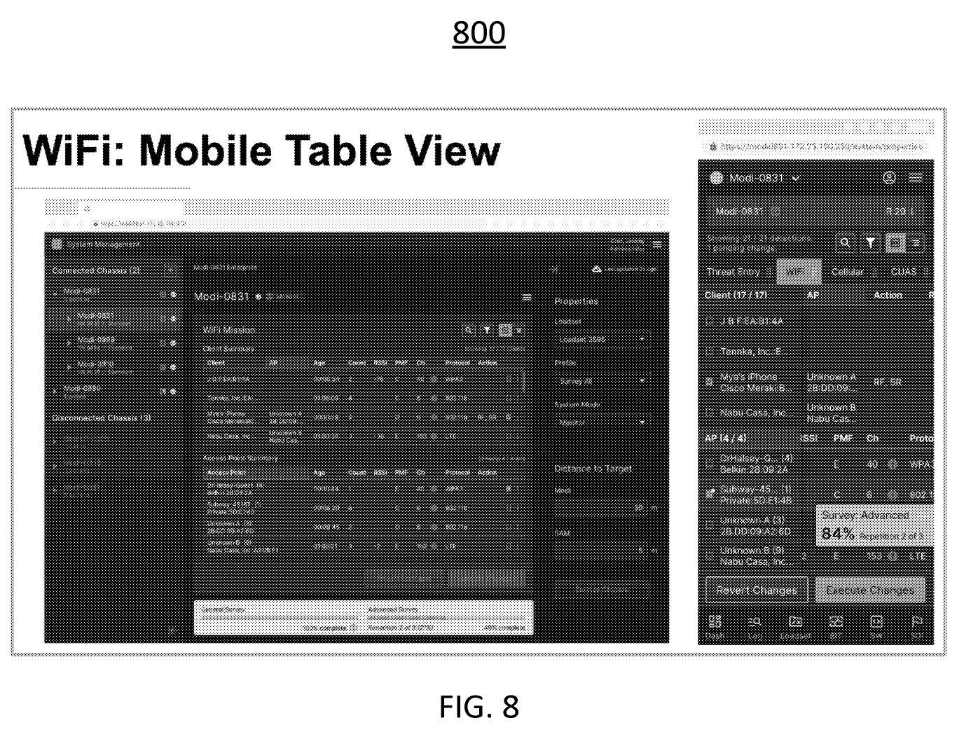

FIG. 8 illustrates interface 800 showing WiFi mission execution views in both desktop and mobile formats, demonstrating how the system displays detected wireless clients and access points during counter-RCIED operations.

The left side shows the desktop/tablet view of the WiFi mission interface. The screen displays "Modi-0831" system information with a "WiFi Mission" panel (or “region”) showing two tables. The "Client Summary" table lists detected wireless client devices with columns for Client (MAC address), AP (access point), Age, Count, RSSI, PMF, Ch (channel), and Protocol. Example entries include clients like "J D F:EA:B1:4A," "Tennika, Inc.:E...," and "Mya's iPhone Cisco Meraki:B..." The "Access Point Summary" table below shows detected access points with similar technical columns, listing networks such as "Drfleway-Guest," "Belkin.28.09.2A," "Subway-45Set," and several "Unknown A" entries. At the bottom of the screen, a progress indicator shows mission execution status with "General Survey" at "100% complete" and "Advanced Survey" at "49% complete" with "Repetition 2 of 3 (2/3)" counter.

The right side shows the mobile view of the same WiFi mission interface on a smartphone form factor. The interface displays similar information with the same client and access point tables adapted for the smaller screen. An overlay progress indicator is shown as a badge stating "Survey: Advanced 84% Repetition 2 of 3." This sticky notification overlays the interface and remains visible as operators navigate between different screens or scroll through the client/access point lists, ensuring they maintain awareness of ongoing mission execution progress without needing to return to a specific status screen.

Both views show the unified presentation of detection data from devices 140 across the stack, with tables displaying real-time information about detected wireless threats. The bottom navigation bar provides access to Dashboard, Search, Loadsets, BIT, SW, and Mission functions.

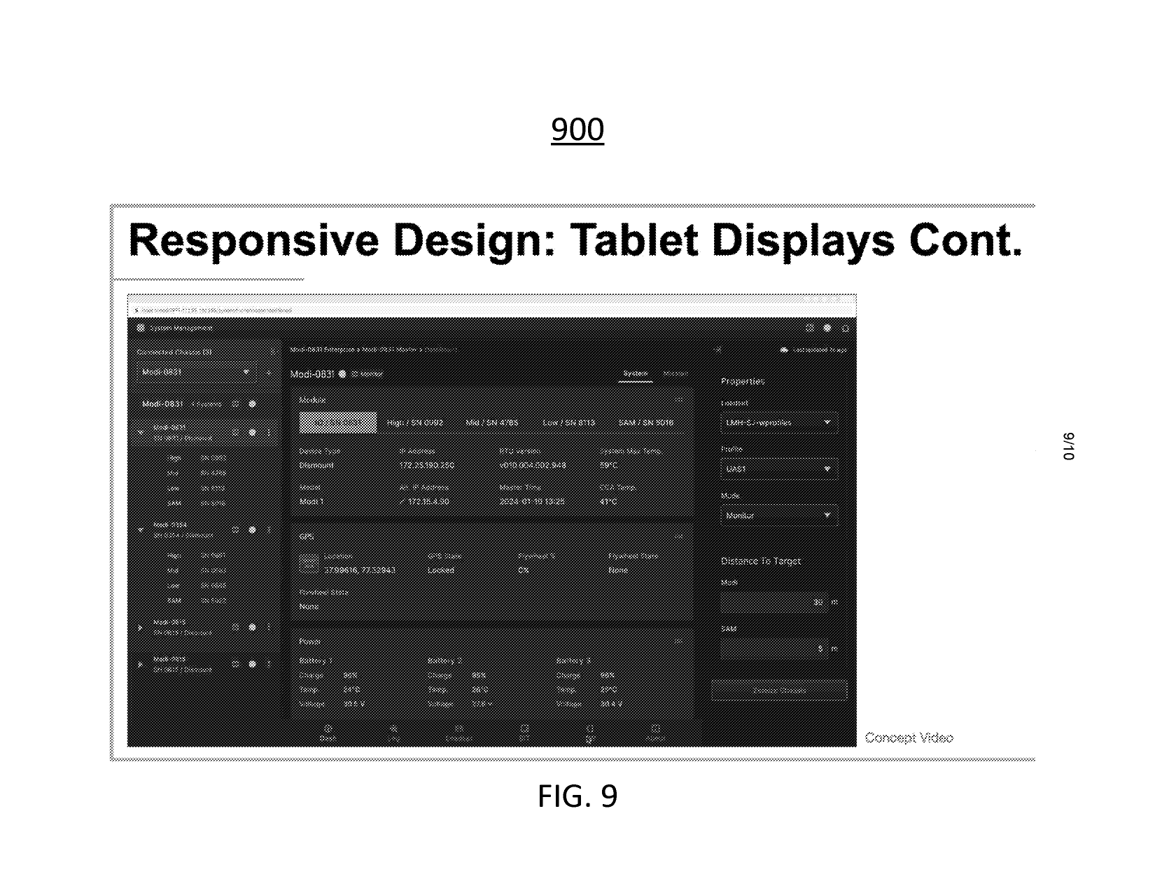

FIG. 9 shows the interface 900 demonstrating the responsive design of the user interface 115 on tablet displays. The interface adapts to the larger tablet form factor by utilizing the increased screen real estate to display multiple information panels simultaneously.

The left panel shows the device tree with "Connected Chassis (3)" displaying the hierarchical structure of available modules. The center panel displays detailed module information for the selected "Modi-0831" device with horizontal tabs for different modules (IO/SN 0831, High/SN 0992, Mid/SN4765, Low/SN8113, SAM/SN5016) and expandable sections showing device parameters including Device Type, Model, GPS location, and Power status with battery information. The right panel shows the Properties configuration controls with Loadset, Profile, Mode selectors, Distance to Target settings, and a Zeroize Chassis button.

The responsive tablet layout efficiently uses horizontal space to present the device inventory, detailed technical parameters, and configuration controls side-by-side, reducing the need for navigation between screens compared to the mobile phone views shown in previous figures. The interface maintains consistent functionality across form factors while adapting the layout to optimize usability for each device type.

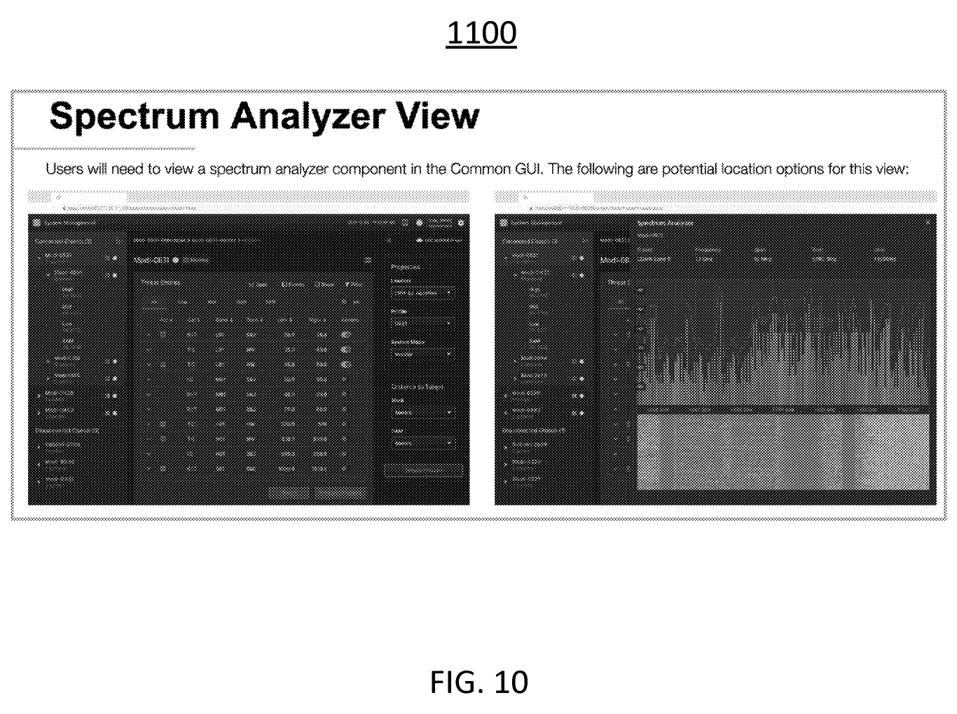

FIG. 10 illustrates interface 1100 showing the spectrum analyzer functionality within the Common GUI.

The left side of the figure shows the threat entry management interface from which the spectrum analyzer can be launched. The interface displays "Modi-0831" with "Monitor" status and includes a "Threat Entries" table with filtering controls (Span, Clients, Dwell, Y Filter) and columns showing threat classifications and parameters. This represents the operational context where operators can access spectrum analysis while monitoring or managing detected threats.

The right side of the figure shows the spectrum analyzer view itself. The spectrum analyzer view presents two complementary visualization panels: a top panel showing a frequency spectrum graph with signal amplitude (in dBm) versus frequency (1.095 GHz to 1.105 GHz range), displaying peaks and valleys of detected RF activity, and a bottom panel showing a time-frequency display with frequency on the horizontal axis and time on the vertical axis, where color intensity represents signal strength creating a spectrogram that scrolls over time. Configuration controls at the top show "CSAW Band 0" with frequency, span, start, and stop settings.

The integration of spectrum analysis directly into the Common GUI is significant because some proprietary vendor applications do not include spectrum analyzer functionality and operators previously required separate standalone spectrum analyzer applications to visualize spectral data. By integrating spectrum analysis into the common GUI interface 115, the system 100 enables operators to move seamlessly from threat detection to spectral analysis without switching applications, maintaining situational awareness in time-sensitive counter-RCIED operations.

Through the systems and methods described herein, routing and management of calls to various subservices for control of software-defined radio systems is provided. The systems and methods described herein enable the ability to individually work on various subservices through authentication while still provided a united interface on the application via the data manager. The data manager enforces consistent authentication and authorization across subservices, reducing vulnerabilities and ensuring access controls. It protects sub-services from being overwhelmed by excessive traffic by managing requests and simplifies access and routing for clients while abstracting the complexity of the underlying architecture. In this manner, it provides a scalable solution for various incompatible subservices to provide commands and access for various software defined radios.

The approaches described above can be implemented, for example, using a programmable computing system executing suitable software instructions or it can be implemented in suitable hardware such as a field-programmable gate array (FPGA) or in some hybrid form. For example, in a programmed approach the software may include procedures in one or more computer programs that execute on one or more programmed or programmable computing system (which may be of various architectures such as distributed, client/server, or grid) each including at least one processor, at least one data storage system (including volatile and/or non-volatile memory and/or storage elements), at least one user interface (for receiving input using at least one input device or port, and for providing output using at least one output device or port). The software may include one or more modules of a larger program, for example, that provides services related to the design, configuration, and execution of data processing graphs. The modules of the program (e.g., elements of a data processing graph) can be implemented as data structures or other organized data conforming to a data model stored in a data repository.

The software may be stored in non-transitory form, such as being embodied in a volatile or non-volatile storage medium, or any other non-transitory medium, using a physical property of the medium (e.g., surface pits and lands, magnetic domains, or electrical charge) for a period of time (e.g., the time between refresh periods of a dynamic memory device such as a dynamic RAM). In preparation for loading the instructions, the software may be provided on a tangible, non-transitory medium, such as a CD-ROM or other computer-readable medium (e.g., readable by a general or special purpose computing system or device), or may be delivered (e.g., encoded in a propagated signal) over a communication medium of a network to a tangible, non-transitory medium of a computing system where it is executed. Some or all of the processing may be performed on a special purpose computer, or using special-purpose hardware, such as coprocessors or field-programmable gate arrays (FPGAs), dedicated, application-specific integrated circuits (ASICs), or graphics processing units GPUs (e.g., for efficient execution of large language models or other machine learning/artificial intelligence models). The processing may be implemented in a distributed manner in which different parts of the computation specified by the software are performed by different computing elements. Each such computer program is preferably stored on or downloaded to a computer-readable storage medium (e.g., solid state memory or media, or magnetic or optical media) of a storage device accessible by a general or special purpose programmable computer, for configuring and operating the computer when the storage device medium is read by the computer to perform the processing described herein. The inventive system may also be considered to be implemented as a tangible, non-transitory medium, configured with a computer program, where the medium so configured causes a computer to operate in a specific and predefined manner to perform one or more of the processing steps described herein.

What is claimed is:

1. A system for controlling software defined radio devices, comprising:
a plurality of subservices, each subservice of the plurality of subservices configured to communicate with devices of a respective device type using a respective protocol, wherein a first subservice is configured to communicate with devices of a first device type using a first protocol and a second subservice is configured to communicate with devices of a second device type using a second protocol, incompatible with the first protocol;
one or more processors, coupled with memory, the one or more processors configured to:
maintain an identification of the plurality of subservices and their device types;
receive, from a user device, a request in a first form for information related to a first device, the first device being of the first device type;
determine, based on the device type of the first device, that the first device is associated with the first subservice;
transform the request from the first form to a second form compatible with the first subservice, the transformation being based at least in part on the first protocol;
provide the request in the second form to the first subservice;
receive, from the first subservice, the information in the second form;
transform the information from the second form to the first form compatible with a display, the transformation being based at least in part on the first protocol; and
display, on the user device, the information related to the first device in the first form.

2. The system of claim 1, wherein the one or more processors are further configured to:
receive a second request from the user device in the first form for information related to a second device, the second device being of the second device type;
determine, based on the device type of the second device, that the second device is associated with the second subservice;
transform the second request from the first form to a third form compatible with the second subservice, the transformation being based at least in part on the second protocol;
provide the second request in the third form to the second subservice;
receive, from the second subservice, the information in the third form;
transform the information from the third form to the first form compatible with a display, the transformation being based at least in part on the second protocol; and
display the information from both the first subservice and second subservice on the user device in the first form.

3. The system of claim 1, wherein to transform the information from the second form to the first form compatible with the display, the one or more processors are configured to remove information related to the first subservice.

4. The system of claim 1, wherein to transform the information from the second form to the first form compatible with the display, the one or more processors are configured to render the information in the first form.

5. The system of claim 1, wherein the one or more processors are configured to receive a request to modify a third subservice of the plurality of subservices.

6. The system of claim 1, wherein the one or more processors are configured to authenticate a request to edit a third subservice of the plurality of subservices.

7. The system of claim 1, wherein each subservice of the plurality of subservices maintains a data repository of information related to the device type associated with a respective subservice.

8. The system of claim 1, wherein the one or more processors are configured to cache the information in the second form for at least a period of time.

9. The system of claim 1, wherein the devices are software defined radio devices.

10. The system of claim 1 wherein transforming the request from the first form to the second form includes performing a semantic mapping of property names from the first form to proprietary property naming conventions of the first protocol.

11. The system of claim 1 wherein the one or more processors are further configured to receive a zeroization command from the user device and execute remote sanitization of one of the devices associated with the plurality of subservices.

12. The system of claim 1 wherein the one or more processors are further configured to receive built-in test results from the first subservice indicating a fault condition in the first device, and display health status information on the user device indicating the fault condition.

13. A method for controlling software defined radio devices, comprising:
maintaining, by one or more processors coupled with memory, an identification of a plurality of subservices, each subservice of the plurality of subservices configured to communicate with devices of a respective device type using a respective proprietary protocol, wherein a first subservice is configured to communicate with devices of a first device type using a first proprietary protocol and a second subservice is configured to communicate with devices of a second device type using a second proprietary protocol, incompatible with the first proprietary protocol;
receiving, by the one or more processors, from a user device, a request in a first form for information related to a first device, the first device being of the first device type;
determining, by the one or more processors, based on the device type of the first device, that the first device is associated with the first subservice;
transforming, by the one or more processors, the request from the first form to a second form compatible with the first subservice, the transformation being based at least in part on the first proprietary protocol;
providing, by the one or more processors, the request in the second form to the first subservice;
receiving, by the one or more processors, from the first subservice, the information in the second form;
transforming, by the one or more processors, the information from the second form to the first form compatible with a display, the transformation being based at least in part on the first proprietary protocol; and
displaying, on the user device, the information related to the first device in the first form.

14. The method of claim 13, further comprising:
receiving, by the one or more processors, a second request from the user device in the first form for information related to a second device, the second device being of the second device type;
determining, by the one or more processors, based on the device type of the second device, that the second device is associated with the second subservice;
transforming, by the one or more processors, the second request from the first form to a third form compatible with the second subservice, the transformation being based at least in part on the second proprietary protocol;
providing, by the one or more processors, the second request in the third form to the second subservice;
receiving, by the one or more processors, from the second subservice, the information in the third form;
transforming, by the one or more processors, the information from the third form to the first form compatible with a display, the transformation being based at least in part on the second proprietary protocol; and
displaying the information from both the first subservice and second subservice on the user device in the first form.

15. The method of claim 13, wherein transforming the information from the second form to a first form compatible with the display comprises removing, by the one or more processors, information related to the first subservice.

16. The method of claim 13, wherein transforming the information from the second form to the first form compatible with the display comprises rendering, by the one or more processors, the information in the first form.

17. The method of claim 13, comprising receiving, by the one or more processors, a request to modify a third subservice of the plurality of subservices.

18. A non-transitory computer-readable medium storing instructions that, when executed by one or more processors, cause the one or more processors to perform operations comprising:
maintaining, by one or more processors coupled with memory, an identification of a plurality of subservices, each subservice of the plurality of subservices configured to communicate with devices of a respective device type using a respective proprietary protocol, wherein a first subservice is configured to communicate with devices of a first device type using a first proprietary protocol and a second subservice is configured to communicate with devices of a second device type using a second proprietary protocol, incompatible with the first proprietary protocol;
receiving, by the one or more processors, from a user device, a request in a first form for information related to a first device, the first device being of the first device type;
determining, by the one or more processors, based on the device type of the first device, that the first device is associated with the first subservice;
transforming, by the one or more processors, the request from the first form to a second form compatible with the first subservice, the transformation being based at least in part on the first proprietary protocol;
providing, by the one or more processors, the request in the second form to the first subservice;
receiving, by the one or more processors, from the first subservice, the information in the second form;
transforming, by the one or more processors, the information from the second form to the first form compatible with a display, the transformation being based at least in part on the first proprietary protocol; and
causing display, on the user device, the information related to the first device in the first form.

19. A graphical user interface for controlling software-defined radio devices, the graphical user interface displayed on a user device and comprising:
a device inventory display region configured to display a hierarchical listing of a plurality of software-defined radio devices, wherein the plurality of software-defined radio devices include devices from multiple vendors having incompatible proprietary protocols;
a status display region configured to simultaneously display operational status information from the plurality of software-defined radio devices in a common format, wherein the operational status information is transformed from vendor-specific formats; and
a control interface region configured to receive commands from an operator and transmit the commands to a data handler for transformation and routing to appropriate subservices controlling respective software-defined radio devices,
wherein the graphical user interface provides unified control of the plurality of software-defined radio devices from the multiple vendors through a single interface without requiring the operator to access separate vendor-specific applications.

20. The graphical user interface of claim 19, wherein the device inventory display region displays a modular stack comprising radio modules from at least two different vendors in a single view.
